(19) United States
(12) Patent Application Publication
(10) Pub. No.: US 2008/0168507 A1
(43) Pub. Date: Jul. 10, 2008

(54) CONTENT DISTRIBUTION ARBITRATION APPARATUS AND METHOD FOR THE SAME

(75) Inventors: Keiichi Teramoto, Kawasaki-shi (JP); Kotaro Ise, Saitama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/958,065

(22) Filed: Dec. 17, 2007

(30) Foreign Application Priority Data
Dec. 21, 2006 (JP) 2006-344826

(51) Int. Cl. H04N 7/18

(52) U.S. Cl. 725/74

(57) ABSTRACT

A content distribution arbitration apparatus is built in a LAN connected to a plurality of content receivers receiving a content transmitted in multicast from a content distribution server through a network, and includes a first memory to store constraint information indicating the number of channels capable of receiving contents simultaneously in the LAN and a communication band, a second memory to store connection information indicating a distribution channel used by each of the content receivers which receives a content, a message receiver to receive a message for requesting distribution of content by a desired distribution channel, and a controller to determine whether the message is accepted based on request of the message, the constraint information and the connection information.

### CROSS-REFERENCE TO RELATED APPLICATIONS

This application is based upon and claims the benefit of priority from prior Japanese Patent Application No. 2006-344826, filed Dec. 21, 2006, the entire contents of which are incorporated herein by reference.

### BACKGROUND OF THE INVENTION

1. Field of the Invention

The present invention relates to a content distribution arbitration apparatus and method for the same.

2. Description of the Related Art

In recent years, video instruments such as digital televisions, digital recorders, personal computers have been remarkably developed according to the spread of digital home electric appliances.

Further, digitalization of television broadcasting such as digital broadcasting for ground digital broadcasting and cellular phones has advanced. Furthermore, the video distribution via Internet has been expanded. There is general how to use the digital home electric appliances so that in home these are connected to a network based on a standard such as DLNA (Digital Living Network Alliance)™, and the video content that a certain instrument retains is viewed over the network.

There are two types of a VOD type and a broadcast type in a implementation configuration of video distribution through Internet. The VOD type is a configuration that a user can call up from a distribution server the content that he or her wants to watch when he or her wants to watch. The broadcast type is a configuration to be near a conventional broadcast to deliver a program from a distribution server according to a time table decided for every channel. In the broadcast type, there is a distribution system which uses a multicast in the network that a provider provides and makes it possible to distribute a high-fidelity video while assuring a band. There have been proposed some systems for distributing a high-fidelity digital video or audio via such an Internet to a home. For example, JP-A 2005-328239 (KOKAI) provides a system for guaranteeing the quality of a communications band and so on by a video distribution service in multicast over an IP network.

However, in the system imposing constrains on the communications band or the number of broadcast channels distributing at the same time, limitation of the number of devices available (receivable) in home or objects is not considered. In other words, when distribution request for the number of channels more than the upper limit is imposed to the network whose quality is guaranteed the at the same time, a new communication channel acquisition request over the upper limit is canceled based on the constraints on the Internet side such as the communications band or the number of channels.

In the case that a user uses a plurality of AV devices at the same time under such a network condition, since the existing system cannot perform communications over the constraint number of channels, the channel switching process or priority control cannot be done according to the expectation.

In a conventional system, the technology to do a guarantee of communication quality of communications band and so on is established. However, in a system constrained by the communications band or the number of simultaneous distribution broadcast channels, the limitation on the number of devices which are usable (receivable) in common in home or objects is unconsidered particularly. In other words, under environment having constraint on the Internet side about the communications band or the number of channels, when a user uses a plurality of AV devices at the same time, the switching process of communications channels more than the constraint number or the priority control of channels cannot be executed according to the expectation.

It is an object of the present invention to provide a content distribution arbitration apparatus which makes it possible to use adaptively a limited number of distribution channels distributed in home among a plurality of AV devices, and a method for the same.

### BRIEF SUMMARY OF THE INVENTION

An aspect of the present invention provides a content distribution arbitration apparatus built in a LAN connected to a plurality of content receivers receiving a content transmitted in multicast from a content distribution server through a network, the apparatus comprising: a first memory to store constraint information indicating the number of channels capable of receiving contents simultaneously in the LAN and a communication band; a second memory to store connection information indicating a distribution channel used by each of the content receivers which receives a content; a message receiver to receive a message for requesting distribution of content by a desired distribution channel; and a controller to determine whether the message is accepted based on request of the message, the constraint information and the connection information.

### BRIEF DESCRIPTION OF THE SEVERAL VIEWS OF THE DRAWINGS

FIG. 1 is a schematic block diagram of a communication system according to one embodiment.

FIG. 2 is a block diagram of the first configuration example of LAN.

FIG. 3 is a block diagram of the second configuration example of LAN.

FIG. 4 is a block diagram of the third configuration example of LAN.

FIG. 5 is a block diagram of a broadcast distribution arbitration apparatus according to the embodiment.

FIG. 6 is a diagram showing an example of a format of distribution constraint information.

FIG. 7 is a diagram showing an example of a format of distribution connection information.

FIG. 8 is a flowchart illustrating an example of a procedure for determining whether the controller of a broadcast distribution arbitrator accepts or not a content distribution request message when the controller received the content distribution request message.

FIG. 9 is a diagram showing an example of a broadcast distribution sequence.

FIG. 10 is a block diagram of a broadcast distribution arbitration apparatus according to another embodiment.

FIG. 11 is a flowchart illustrating another example of a procedure for determining whether the controller of a broadcast distribution arbitrator accepts or not a content distribution request message when the controller received the content distribution request message.

FIG. 12 is a diagram showing another example of a broadcast distribution sequence.

FIG. 13 is a diagram showing an example of a format of a receiving mode inquiry message transmitted by the broadcast distribution arbitration apparatus.

FIG. 14 is a diagram showing an example of a format of a receiving mode reply message issued by a AV device.

FIG. 15 is a diagram showing an example of a format of an entry of distribution request channel receiving mode information.

FIG. 16 is a diagram showing another example of a broadcast distribution sequence.

FIG. 17 is a diagram showing an example of a format of distribution registration information.

FIG. 18 is a diagram of a GUI screen.

FIG. 19 is a diagram showing another example of a broadcast distribution sequence.

### DETAILED DESCRIPTION OF THE INVENTION

There will now be described an embodiment of the present invention in conjunction with the accompanying drawings.

### First Embodiment

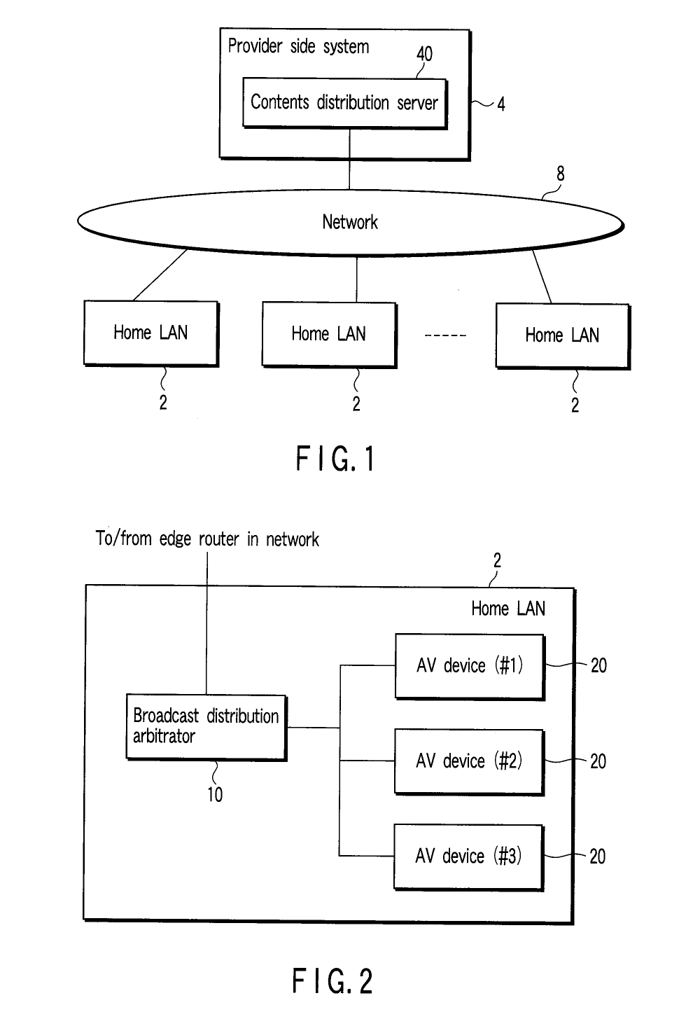

As shown in FIG. 1, the present communications system contains a home LAN (referred to as LAN hereinafter) 2 such as a home network provided in the home of a user, for example, and a provider side system 4. Each LAN 2 and the provider side system 4 can communicate with each other through a (wide area) network 8 such as Internet.

The provider side system 4 is a system for a service provider providing a distribution service of broadcast type content (for example, a video content (including audio) or an audio content), for example, an ISP over Internet or a broadcast distribution provider.

The provider side system 4 includes a content distribution server 40 which delivers a plurality of content to a plurality of users. Even if the content distribution server 40 may be a server connected directly to the network 8, and a sever connected to the network via a device of another router (or broadband router), etc.

In the present embodiment, the network 8 is assumed to be Internet. The embodiment may use a network other than Internet as the network 8.

Also, the broadcast distribution server 40 is assumed to provide a broadcast type video content service using multicast via a network (referred to as Internet hereinafter) 8.

As shown in FIG. 2, the LAN 2 contains a broadcast distribution arbitrator 10 and a plurality of AV devices 20 (e.g., three AV devices #1 to #3). The AV device (content receiver) 20 has a function for receiving a broadcast distribution via Internet 8 from the content distribution server 40 and displaying it, and corresponds to, for example, a TV, a video recorder or another household electric appliance.

The AV device 20 may be controlled by, for example, a user by means of a remote controller such as an infrared remote controller or a wireless remote controller. Also, it may be controlled with a terminal such as a personal computer via the LAN 2 (or via the Internet 8 and LAN 2). Further, the AV device 20 may be controlled by a method aside from the above.

The broadcast distribution arbitrator 10 arbitrates a content distribution request issued by each AV device 20 (alternatively arbitrates receiving of each AV device 20). The broadcast distribution arbitrator 10 is assumed to use a communication device such as a router capable of processing a multicast request.

In FIG. 2, the broadcast distribution arbitrator 10 is realized in a form that the function of the broadcast distribution arbitrator 10 is provided on the router of the LAN 2. The broadcast distribution arbitrator 10 having a function of a router is connected to the Internet 8. Each AV device 20 can be connected to the Internet 8 via the broadcast distribution arbitrator 10 having a function as a router.

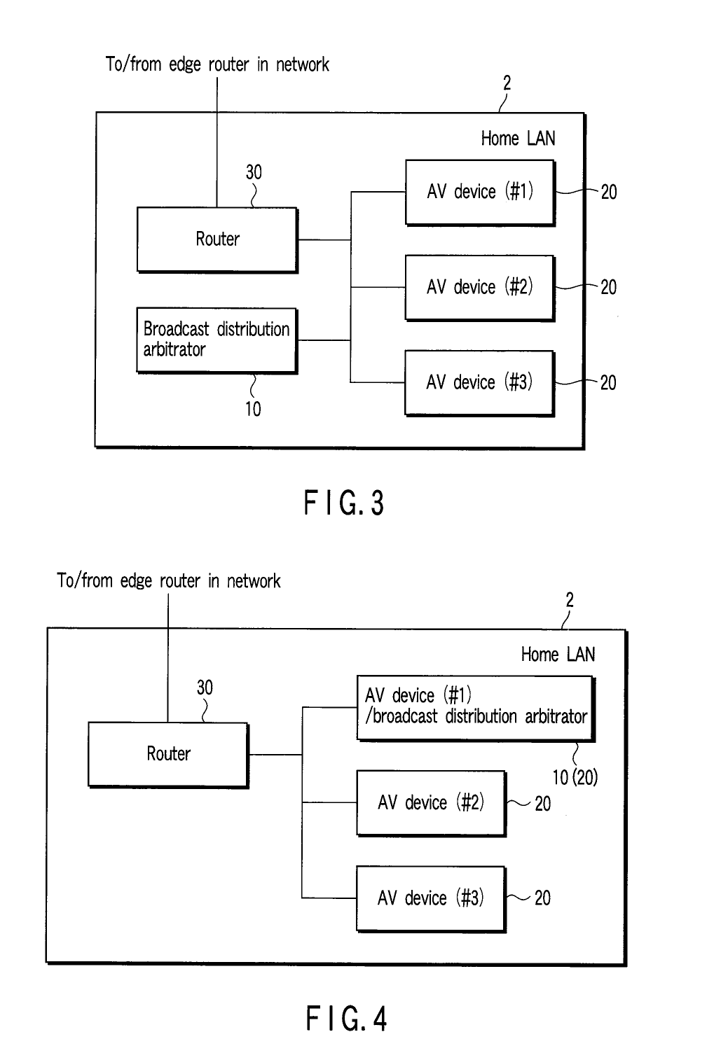

In the configuration of FIG. 3, the broadcast distribution arbitrator 10 is independent of the router 30 of the LAN 2. It is realized as a dedicated node being at a position such as an Ethernet (TM) switch and a wireless LAN switch. In this case, if the broadcast distribution arbitrator 10 is at a position at which the message transmitted by each AV device 20 can be always received before the router 30 receives the message, the broadcast distribution arbitrator 10 may be connected to any position in the LAN 2.

In FIG. 2 and FIG. 3, the broadcast distribution arbitrator 10 is provided to be independent of the AV device 20. In the configuration of FIG. 4, the broadcast distribution arbitrator 10 is realized in a form of building a function of the broadcast distribution arbitrator into the AV device 20 located at a position such as an Ethernet (TM) switch and a wireless LAN switch. In this case, the AV device 20 which built in the function of the broadcast distribution arbitrator 10, (particularly a function part related to the broadcast distribution arbitrator 10) operates as the broadcast distribution arbitrator 10 with respect to the AV device oneself (a part thereof as AV function) and other AV devices 20. In this case, if the AV device 20 which operates as the broadcast distribution arbitrator 10 is at a position at which the message transmitted by another AV device 20 is received before the router 30 of the LAN 2 receives the message, it may be connected to what position in LAN 2. In this case, the message transmitted by the AV device built in the function of the broadcast distribution arbitrator 10 (the part of AV function) is received with the AV device 20 oneself (the functional part related to the broadcast distribution arbitrator 10) before the router 30 of the LAN 2 receives it.

The LANs of FIGS. 2 and 3 can be considered to be the same configuration in function. The internal concrete configuration of each LAN 2 may be identical to or different from that of another LAN. For example, the broadcast distribution arbitrator 10 may take any one of the configurations of FIGS. 2 to 4 or the AV devices 20 to be controlled in the LAN 2 may be connoted.

In the embodiment, the AV devices 20 to be controlled in the LAN 2 are assumed to be able to receive only one channel. However, all or some of the AV devices 20 may receive a plurality of channels at the same time. In the case of the latter, one AV device 20 capable of receiving a plurality of channels at the same time has only to be treated as a plurality of AV devices.

When the AV devices 20 in the LAN 2 are assumed to be capable of receiving only one channel at the same time, a plurality of AV devices 20 are assumed to be connected to each other in the LAN 2. However, when there is an AV device 20 capable of receiving a plurality of channels at the same time as described above, a single AV device 20 capable of receiving a plurality of channels at the same time in the LAN 2 may be an object to be controlled.

In the present embodiment, when a user related to the LAN 2 receives a distribution service with the content distribution server 40, various agreements (contracts) are done between the user related to the LAN and the service provider related to the content distribution server 40. As one of the agreements, it is assumed that the constraint condition C1 related to the upper limit of the number of channels and the constraint condition C2 related to the upper limit of the communication band are set when the user enjoys the content distribution service. For example, a configuration is considered which the service provider prepares a plurality of kinds of courses wherein fee structures or constraint condition are prescribed beforehand, and the user selects a desired course from the courses.

The group of AV terminals in the LAN 2 can receive a content distribution service in a range of those constraints. The broadcast distribution arbitrator 10 of the present embodiment arbitrates the content distribution request/content receiving between the AV terminals so that those constraints are satisfied.

The constraint C1 related to the upper limit of the number of channels contains the following condition:

“The maximum number of channels capable of receiving at the same time=n (2, for example)”.

The constraint C2 related to the upper limit of communications band may be the following conditions:

1) “The upper limit of communications band capable of receiving per one channel=U1 (20 Mbps, for example), or

2) “The upper limit of a total of communications bands of all channels capable of receiving at the same time=U2 (40 Mbps, for example).

In addition, There are a content of communication band 20 Mbps and a content of communication band 5 Mbps.

In the case of the constraint of “the maximum number of channels capable of receiving at the same time=8 and the upper limit of the sum of communications bands of all channels capable of receiving at the same time=50 Mbps,

1) the content of communications band 20 Mbps is limited to the number of channels capable of receiving at the same time=2,

2) the content of communications band 5 Mbps is limited to the number of channels capable of receiving at the same time=8”,

3) at the same time the content of 20 Mbps are received in 2 channels and the content of 5 Mbps are received in 0-2 channels,

4) at the same time the content of 20 Mbps are received in one channel and the content of 5 Mbps are received in 0-6 channels,

5) if the content of 20 Mbps is allocated to 0 channel (i.e., the content of 20 Mbps are requested), the content of 5 Mbps are received in 1-8 channels at the same time.

It should be noted that the more complex constraints are settable.

In other word, the broadcast distribution arbitrator 10 of the present embodiment arbitrates distribution of the content in a range to satisfy the constraint.

For example, in FIG. 2, in the case that there is a constraint (constraint C1) to be able to receive the content only to two channels at the same time, when a new AV device (#3) transmits a content distribution request for one channel in a state that each of the AV devices (#1) and (#2) receive the broadcast distribution by one channel from the content distribution server 40 via the broadcast distribution arbitrator 10,

the broadcast distribution arbitrator 10 performs control including to approve the content distribution request, to discard the content distribution request, to enable the watching and hearing of the AV device (#3), to disenable the watching and hearing of the AV device (#3), etc., based on the content of the content distribution request, the content of constraint, current watching/hearing state of the AV devices (#1) and (#2).

As shown in FIG. 5, the broadcast distribution arbitrator 10 comprises a distribution request message processor 11 to receive a content distribution request message issued by another device (each AV device 20 of FIGS. 2-4) and analyze the content, a distribution constraint information recorder 12 to record distribution constraint information including the number of concurrent communication channels and communication band constrained due to communication quality of the Internet connection side, a distribution connection information holder 13 to hold distribution connection information concerning the distribution channel currently used and the distribution request instrument (each AV device 20 of FIGS. 2-4), and a controller 14 to perform arbitration control and other control based on the request content of content distribution request message analyzed by the distribution request message processor 11, distribution connection information held in the distribution limitation information recorded on the distribution constraint information recorder 12 and distribution connection information held in the distribution connection information holder 13, a communication interface (LAN communication I/F) 18 for the LAN 2, and a communication interface (WAN communication I/F) 19 for Internet 8.

Because the broadcast distribution arbitrator 10 and AV device 20 are mounted on the same apparatus in the example of FIG. 4, when the broadcast distribution arbitrator 10 and AV device (#1) are realized by a program, the communication between the broadcast distribution arbitrator 10 and the AV device (#1) becomes interprocess communication.

In the case of the configuration examples of FIGS. 3 and 4, the WAN communication I/F19 is unnecessary, and the distribution constraint information recorder 12 is connected to the LAN communication I/F18 instead of the WAN communication I/F19. The broadcast distribution arbitrator 10 and each AV device 20 are assumed to be compliant with IGMP (Internet Group Management Protocol) v2-IGMP v3.

In the present embodiment, there will be described an example of realizing the content distribution request message by JOIN message of ICMP (using LEAVE message (receiving completion notification message) of IGMP). In other words, the AV device 20 is assumed to issue a JOIN message of IGMP including the multicast address XA corresponding to the channel X when it request the channel X for distribution. The broadcast distribution arbitrator 10 receives the JOIN message of IGMP as a content distribution request message and processes it. The acquirement of the multicast address corresponding to the channel can be carried out by a method of obtaining the address from meta information of the electron program list (EPG and the like) capable of using simultaneously at the time of broadcast distribution, for example.

The broadcast distribution arbitrator 10 limits the number of channels capable of distributing at the same time and communications band based on the constraint concerning the communication quality of the interface side connected to the Internet or a contract condition with a service provider such as ISP or broadcast distributor. For this reason, at the time of initial setting of the broadcast distribution arbitrator 10, distribution constraint information such as the available communication band and the number of channels capable of communicating at the same time is determined based on the communication quality constraint and contract condition between the broadcast distribution instrument 10 and the management server of the service provider arranged on the Internet 8. For example, the content distribution server 40 may serve as the management server, or may be a server installed separately from the content distribution server 40.

For example, the service provider prepares the constraints corresponding to a plurality of kinds of fees. When a user accesses the management server through the Internet and selects a constraint from among those constraints, the management server sets all or a part of the distribution constraint information to the distribution constraint information recorder 12 of the broadcast distribution arbitrator 10 through the Internet 8.

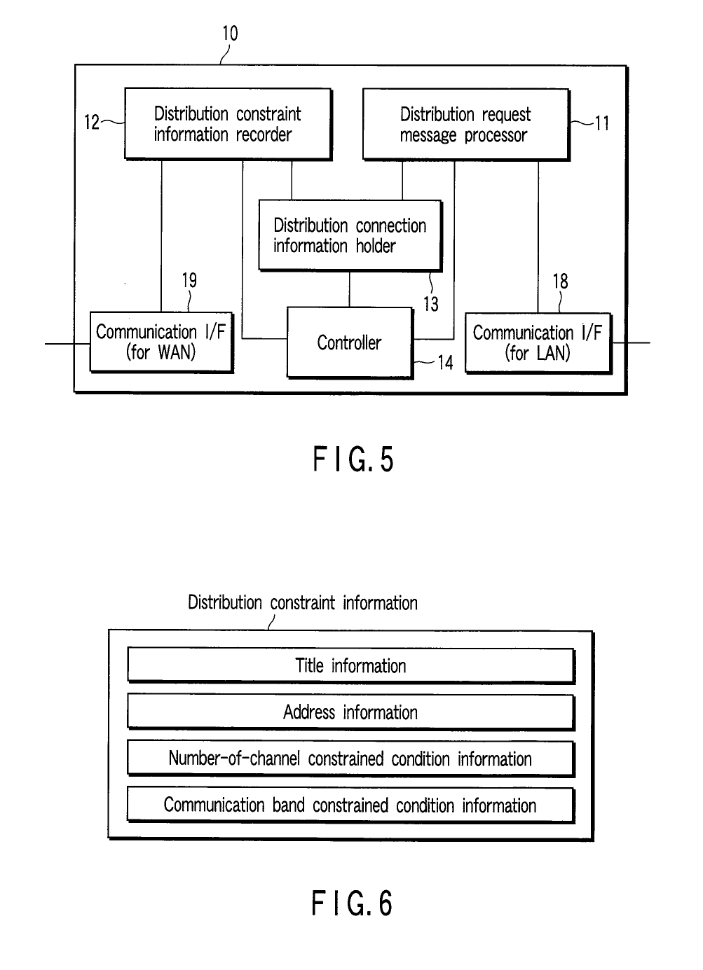

An example of a format of distribution constraint information is shown in FIG. 6. In this example, the distribution constraint information is formed of “name information” indicating a service provider such as ISP or a broadcast provider, “address information” indicating an IP address of the content distribution server 40, “the number-of-channels constraint information” indicating the constraint C1 concerning the upper limit of the number of channels at the time of receiving a distribution service (the maximum number of channels capable of receiving at the same time), and “communications band constraint information” indicating the constraint C2 concerning the upper limit of communications band at the time of receiving a distribution service (for example, maximum communication band per one channel). The format of distribution constraint information is not limited to the above and various kinds of formats are available.

The broadcast distribution arbitrator 10 records distribution connection information to the distribution connection information holder 13 by receiving the JOIN message issued from each AV device 20 and a message sent back from each AV device 20 after issue of membership query.

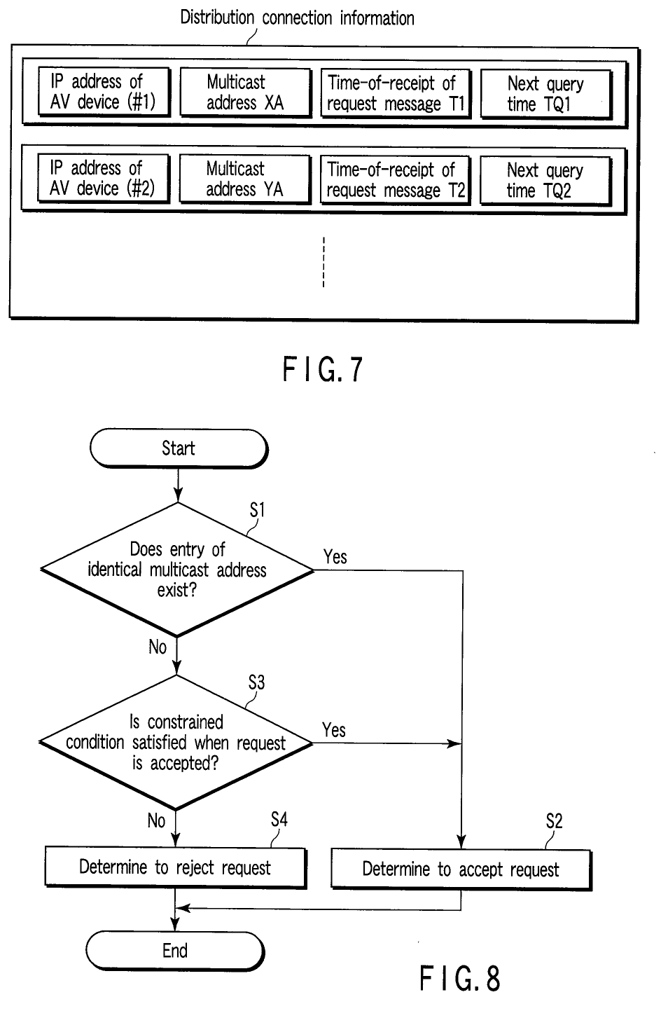

An example of a format of distribution connection information is shown in FIG. 7. This example shows each entry of the distribution connection information when channels corresponding to multicast addresses XA and YA from the AV devices (#1 and #2) are selected and the distribution procedure is completed. In this example, one entry records the IP address of the AV device, the multicast address (the AV device uses), a time at which the content distribution request message was received (the AV device issued), a time at which a query issued on the next time (to the AV device) about the AV device 20 in order to maintain and manage the connection of the AV device 20. In this example, although each entry does not hold the communications band for the multicast address, when the information on the communication band needs for the process of the broadcast distribution attributor, each entry is assumed to hold the communications band. The format of the distribution connection information is not limited to the above, and various kinds of formats are available.

The content of distribution connection information is updated with the controller 14, for example, when the AV terminal 20 transmitted a JOIN message of ICMP starts to receive the content, or when the AV terminal 20 transmits a LEAVE message of ICMP and completes receiving of the content.

For example, when the maximum number of channels capable of receiving at the same time is 2, the LAN 2 can receive contents for two channels corresponding to the multicast addresses XA and YA at the same time as described above. However, the LAN 2 cannot receive the content for a channel corresponding to a further multicast address exceeding the above two multicast addresses, for example, the multicast address XZ at the same time. However, since the AV terminal 20 may have several AV terminals belonging to the multicast addresses, that is, there may be several AV terminals 20 receiving content of either a channel corresponding to the multicast address XA or a channel corresponding to the multicast address YA, even if the maximum number of channels capable of receiving at the same time=n, the entry can retain content more than n.

FIG. 8 shows an example of a procedure for determining whether the controller 14 of the broadcast distribution arbitrator 10 accepts a content distribution request message when it received the content distribution request message. At first the controller 14 compares each multicast address of the entry of the distribution connection information with a multicast address concerning the received content distribution request message. If there is an entry including the same multicast address as that of the received content distribution request message (step S1), the controller 14 determines acceptance of the content distribution request (step S2).

If there is not such an entry, when the controller 14 receives a next content distribution request message, it examines whether all constraints are satisfied (step S3). When all constraints are satisfied, the controller 14 determines acceptance of the content distribution request message (step S2). When all constraints are not satisfied, the controller 14 determines nonacceptance of the content distribution request message (step S4).

The operation of the present embodiment is explained in more detail hereinafter.

FIG. 2 shows a procedure from newly-transmitting of a content distribution request message for one channel from the AV device (#3) to receiving of the broadcast of this channel (or discarding this content distribution request message, when the AV devices (#1) and (#2) receive the broadcast distributions from the content distribution server 40 by one channel, respectively, via the broadcast distribution arbitrator 10.

If the constraint C1 concerning the upper limit of the number of channels is considered, there is a case that the constraint C2 concerning the upper limit of the communication band needs not be considered, for example, a case that if the constraint C1 is satisfied, the constraint C2 is automatically satisfied. In a case that the maximum number of channels capable of receiving at the same time n=2, and the upper limit of the sum of communication bands of all channels capable of receiving at the same time U2=40 Mbps, when the communications band per one channel for any content distributed with the content distribution server 40 is equal to or less than 20 Mbps, if the constraint C1 is satisfied, the content C2 is always satisfied. For the purpose of making explanation easy to understand, there will be described a concrete example that the constraint C1 has only to be considered

It is assumed that a limit (referred to as constraint el hereinafter) of the maximum number of channels capable of receiving at the same time n=2 is imposed to distribution as an example of the constraint C1. At first, the AV devices (#1) and (#2) are assumed to send distribution request messages (satisfying the constraint e1), sequentially, from the state that they receive nothing, and receive the channels X and Y.

The channels X and Y are different broadcasts, and the AV devices (#1) and (#2) participate in a multicast group corresponding to each channel. The multicast addresses corresponding to the AV devices (#1) and (#2) are assumed to be XA, YA. The broadcast distribution arbitrator 10 receives IGMP membership report packets (JOIN messages of ICMP) to each multicast group from respective AV devices 20, and transmit an IGMP membership query packet to all systems (multicast address 224.0.0.1) in the subnets of the LAN 2 or a specific group (multicast addresses XA, YA) regularly. The broadcast distribution arbitrator 10 grasps a member participating in the multicast group by confirming a reply to this packet.

In this way, in the state that Internet connection of the broadcast distribution arbitrator 10 is already completed, and the AV devices (#1) and (#2) receive channels X and Y respectively, the AV device (#3) is assumed to issue a request for receiving a channel Z newly.

This procedure is described as follows.

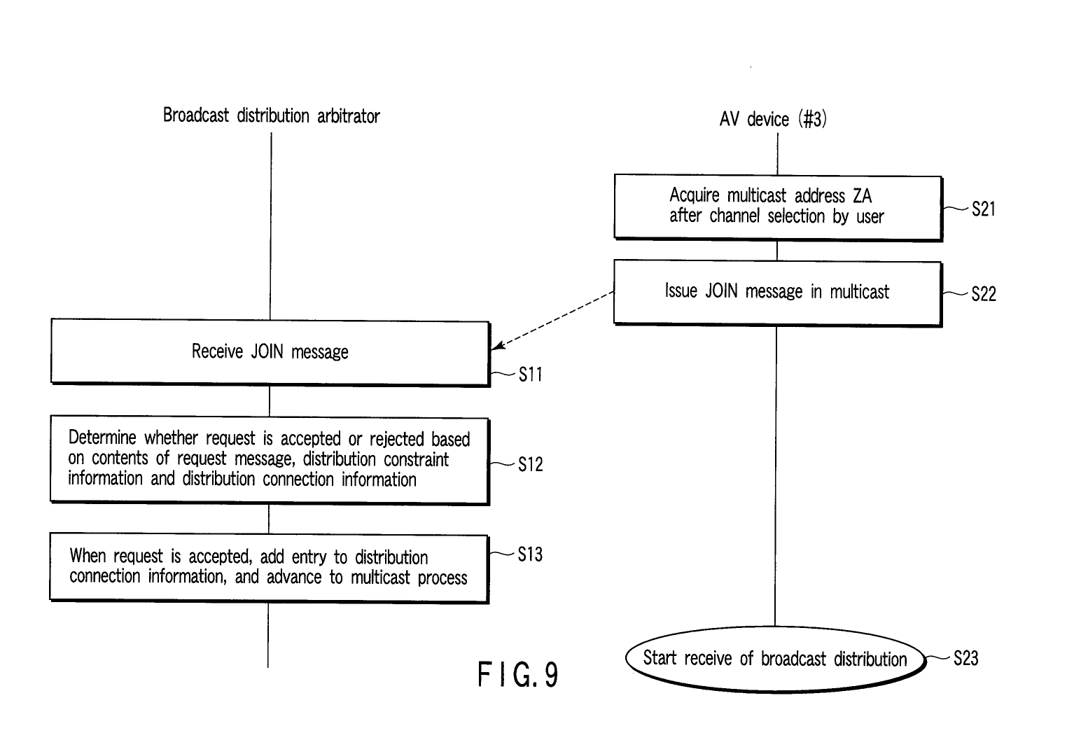

A process done with the broadcast distribution arbitrator 10 and a process done with the AV device (#3) and an example of those sequences are shown in FIG. 9.

For example, when a user performs a channel selection on a GUI screen of an electronic program list or a direct channel selection using a wireless remote controller, the AV device (#3) acquires a multicast address ZA corresponding to the selected channel Z by using meta information incidental on an electron program list provided by way of Internet 8 by a server of a service provider (e.g. the content distribution server 40, the management server described above, or a server installed separately from these servers) (step S21).

The AV device (#3) issues a JOIN message of IGMP calling for participation to the multicast group of the multicast address ZA in multicast in the subnet of LAN 2 (step S22).

When the distribution request message processor 11 receives a JOIN message (i.e., a content distribution message) of IGMP received via the communication I/F 18 for LAN (step S11), the broadcast distribution arbitrator 10 refers to the content of the message, the distribution constraint information saved in the distribution constraint information recorder 12 and the distribution connection information held in the distribution connection information holder 13, and determines whether the distribution request message from the AV device (#3) can be accepted by comparing these information with each other (step S12).

For this determination, at first the broadcast distribution arbitrator 10 checks whether the used channel is the channel Z requested by the AV device (#3) when one or more used channels are in the entry of the distribution connection information held in the distribution information holder 13 in the broadcast distribution arbitrator 10.

Concretely, each multicast address of the entry of the distribution connection information is compared with the multicast address (in this example, ZA) corresponding to the requested channel. If there is an entry containing the multicast address identical to that of the requested channel, the distribution request message can be accepted, because the constraint (in this example, the constraint el is the maximum number of channels capable of receiving at the same time n=2) is satisfied. Besides, because the broadcast distribution packet in the subnet identical to that of the AV device (#3) is transmitted already, one entry has only to be added as the distribution connection information to the distribution information holder 13 based on the content distribution request from the AV device (#3) (step S13).

When there is not the entry containing a multicast address identical to the multicast address (in this example, ZA) corresponding to the requested channel, that is, when the value of the multicast address differs from any entry, the number of unused channels (the number of channels capable of receiving at the same time−the number of channels during receiving) is checked. If one or more unused channels are not available, the content distribution request from the AV device (#3) is refused, resulting in that communications fail.

For example, when the constraint el is the maximum number of channels capable of receiving at the same time n=2, the content distribution request from the AV device (#3) is discarded, because the distribution connection information has no multicast address ZA, and there is no unused channel.

If one or more unused channels are available, the broadcast distribution arbitrator 10 can accept a distribution request message. However, in this case, since the broadcast distribution packet corresponding to the request message is not yet transmitted in the subnet identical to the AV device (#3), the multicast group corresponding to the multicast address specified by the AV device (#3) makes a path to a certain router using a multicast routing protocol suitable for the upper stream router. An entry is added to the distribution connection information holder 13 as distribution connection information based on the distribution request from the AV device (#3) (step S13).

When the above operation of the broadcast distribution arbitrator 10 succeeds, if the distribution connection information has an entry of a channel identical to the requested channel, a broadcast distribution packet is transmitted in the subnet identical to the AV device (#3) via the broadcast distribution arbitrator 10. As a result, the AV device (#3) can start receiving of the packet promptly. However, when there is no entry, the broadcast distribution arbitrator 10 receives a packet addressed to the corresponding multicast address and transmits it to the subnet identical to the AV device ($3). As a result, the AV device (#3) starts to receive the packet (step S23).

According to the present embodiment as described above, by arranging the broadcast distribution arbitrator in home,

in a network system of the guarantee-of-quality type or license authorization type that is constrained on the communications band for the digital video and audio distributed via the Internet or the number of channels capable of receiving at the same time distribution channels, the broadcast distribution arbitrator receives the distribution request message issued from a plurality of AV devices in home. The broadcast distribution arbitrator can switch freely the arbitration process for channel distribution to the AV device and the process for distribution request to the server (router) on the Internet in a range of the upper limit band or the number of distribution channels based on service environment of the Internet connected thereto. When competition may occur, it is possible to arbitrate an acquisition request of a communication channel if necessary, and individual receiving control is enabled in each AV device.

### Second Embodiment

In the first embodiment, when a new content distribution request does not satisfy a constraint, the new content distribution request is refused. For example, in the case that the broadcast distribution arbitrator 10 has a capacity of broadcast distribution only to two different channels, and the AV devices (#1) and (#2) selects different channels, respectively, when the AV device (#3) selects a further different channel, the distribution request is refused.

The second embodiment provides a structure realizing a priority control between the AV device 20 currently selecting one channel and the AV device 20 sent a new content distribution request based on intention of a user. There will be explained control of refusing the request of the AV device (#3) or forcibly canceling one of two channels selected by the AV devices (#1) and (#2) and giving priority to channel selection of the AV device (#3).

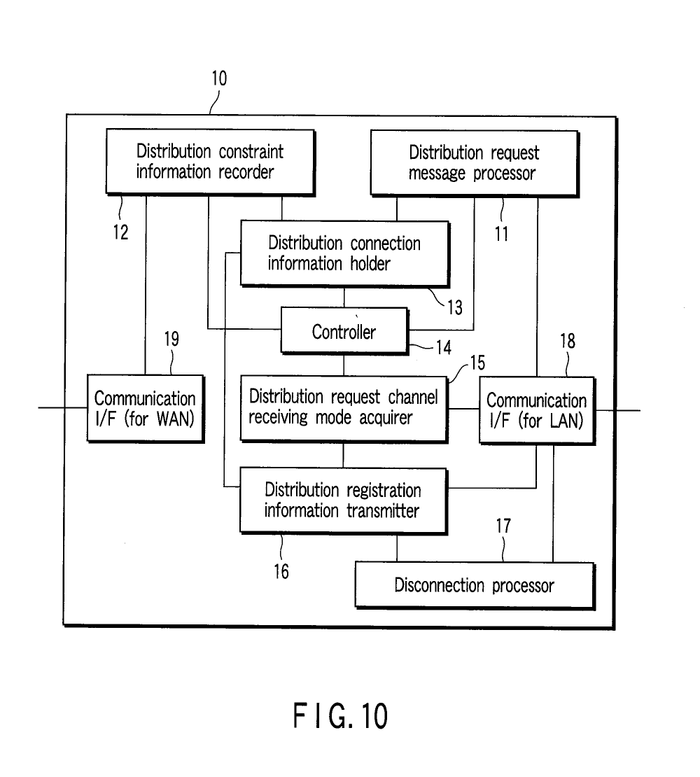

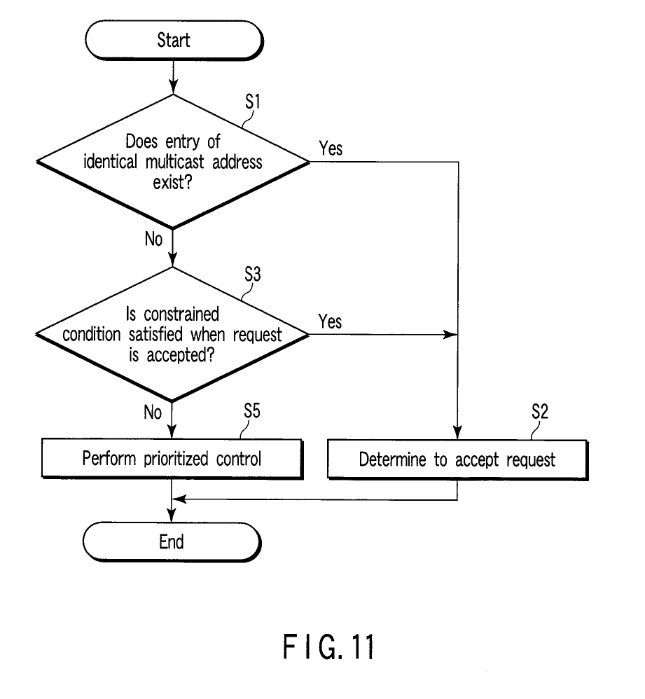

It is explained points different from the first embodiment. As shown in FIG. 10, the broadcast distribution arbitrator 10 of the second embodiment includes additionally a distribution request channel receiving mode acquirer 15, a distribution registration information transmitter 16 and a disconnection processor 17 with respect to the broadcast distribution arbitrator of FIG. 5.

The distribution request channel receiving mode acquirer 15 acquires distribution request channel receiving mode information concerning a channel receiving mode indicating how to perform a watching/hearing process or a video recording process on a content (stream) with respect to each AV device of source of distribution request.

The distribution registration information transmitter 16 transmits, to the AV device of another source of distribution request, the distribution registration information generated from the acquired distribution request channel receiving mode information, identification information (IP address, for example) of the AV device 20 of source of distribution request and the distribution connection information currently used.

The disconnection processor 17 issues a disconnection request to the AV device 20 of another source of distribution request based on a channel switching request from the source-of-distribution-request AV device 20 received the distribution registration information. The disconnection request is used for determining whether the channel switching process is actually done based on a response result from the source-of-distribution-request AV device 20.

FIG. 11 shows a procedure which when the controller 14 of the broadcast distribution arbitrator 10 receives a content distribution request message, it determines whether the content distribution request message is accepted.

At first the controller 14 compares each multicast address of the entry of the distribution connection information with the multicast address concerning the received content distribution request message. If there is an entry containing a multicast address identical to the multicast address concerning the received content distribution request message (step S1), the controller 14 determines to accept the content distribution request (step S2). If there is not such an entry, when the content distribution request message is accepted, it is checked whether all constraints are satisfied (step S3). When all the constraints are satisfied, acceptance of the content distribution request message is determined (step S2). When the constraints are not satisfied, a priority control is done (step S4).

In the priority operation, it is determined not to accept the content distribution request message or to accept it after stopping forcibly receiving of either one of the AV devices 20 already receiving the content. In this time, the determination is done by presenting, for example, distribution registration information to a user and according to selection of the user.

There will be explained a procedure that the broadcast distribution arbitrator 10 knows that the AV device (#1) uses the distribution request channel in what receiving mode (the watching and hearing mode or video recording mode).

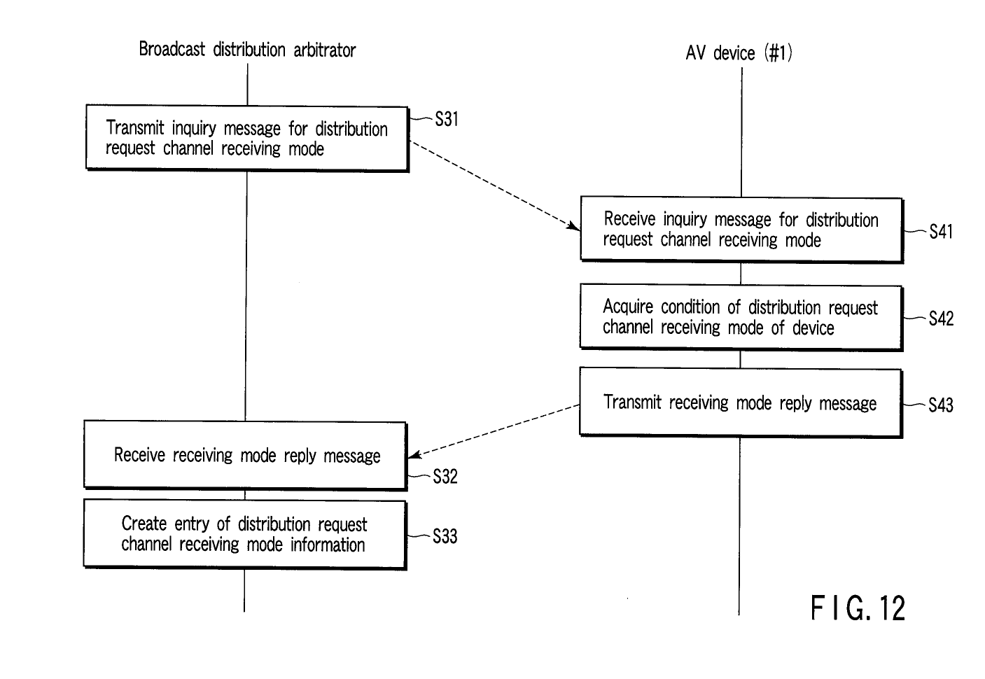

The sequence of this procedure is shown in FIG. 12. When the broadcast distribution arbitrator 10 completes the broadcast distribution process described in the first embodiment based on the distribution request from the AV device of source of distribution request, the distribution request channel receiving mode acquirer 15 transmits to the AV device (#1) a message for inquiring that a user uses distributed broadcast in which of the watching/hearing mode or the video recording mode (step S31). It is noted that the video recording mode includes watching and hearing a video while recording the video.

The AV device (#1) receives the inquiry message (step S41), acquires whether the receiving mode is only the watching/hearing mode or includes the video recording mode (step S42), and makes a receiving mode reply message, and replies to the broadcast distribution arbitrator 10 (step S43).

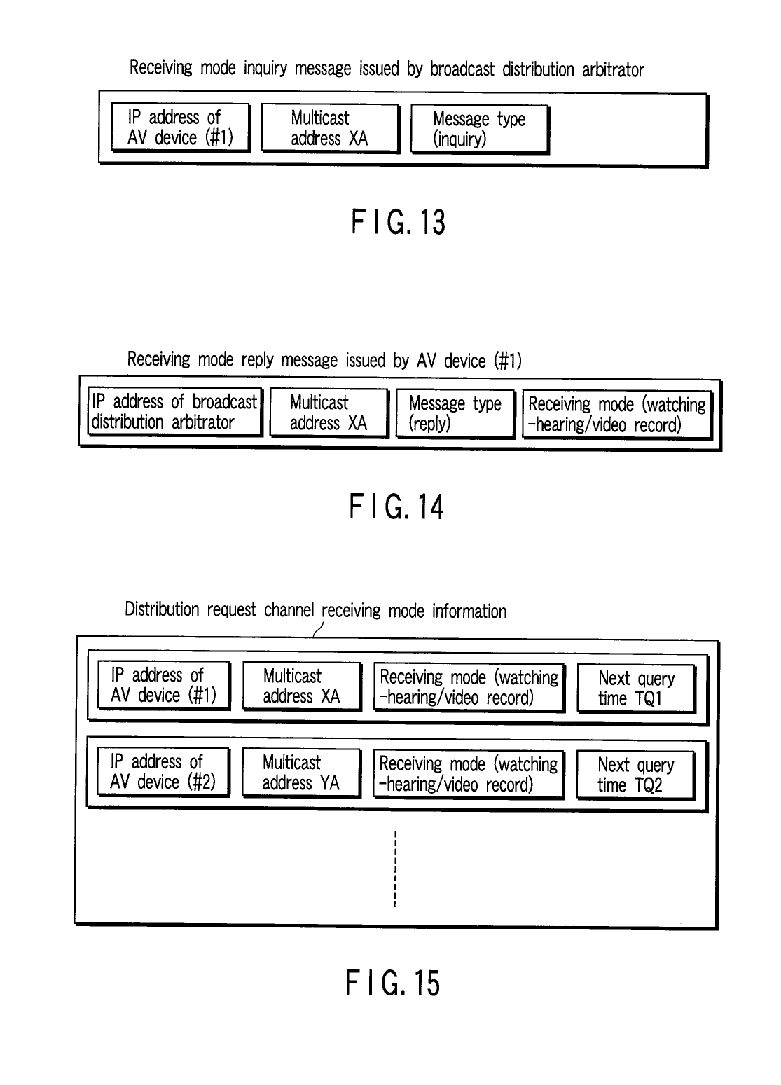

An example of a format of the receiving mode inquiry message transmitted from broadcast distribution arbitrator 10 is shown in FIG. 13. An example of a format of the receiving mode reply message from the AV device (#1) is shown in FIG. 4. The both messages are formed so that the receiving mode can be grasped for every selected channel by retaining a multicast address.

When the distribution request channel receiving mode acquirer 15 receives the receiving mode reply message from the AV device (#1) (step S32), it creates, from the received receiving mode reply message, an entry of distribution request channel receiving mode information corresponding to the AV device (#1) and saves it in its inside (step S33).

An example of a format of an entry of the distribution request channel receiving mode information is shown in FIG. 15. Each entry is assumed to record “an IP address of AV device”, “a multicast address (used by the corresponding AV device)”, and “a receiving mode (of the corresponding AV device). In this example, it is assumed to retain “a time at which a next query is issued to the corresponding AV device” as with the distribution connection information. Also, in this example, the entry does not retain a communication band (in which the corresponding multicast address is used) but it is assumed to retain the communication band when the information of the communication band is needed for the process of the broadcast distribution arbitrator 10. The format of the distribution connection information is not limited to the above and various kinds of formats are available.

When each entry of the distribution request channel receiving mode information is searched for immediately before creating an entry and there is an entry having the same IP address and multicast address, only the receiving mode and next query time have only to be updated and an entry has only not to be created newly. Also, if entries having the same IP address and multicast address of the distribution connection information do not exist at the same time, the corresponding AV device 20 seems to have canceled a broadcast distribution process to the same channel. Therefore, the entry may not be created.

An inquiry message for confirming the receiving mode regularly has only to be sent from the distribution request channel receiving mode acquirer 15 to each AV device 20 corresponding to each entry registered in the distribution request channel receiving mode information based on the next query time in each entry. This makes it possible to grasp always the receiving mode in the latest state with the broadcast distribution arbitrator 10.

There will be explained a procedure that the AV device (#3) issues a request for receiving the channel Z newly in the state that the AV devices (#1) and (#2) receive channels X and Y, respectively, and the operation desired by the user is executed.

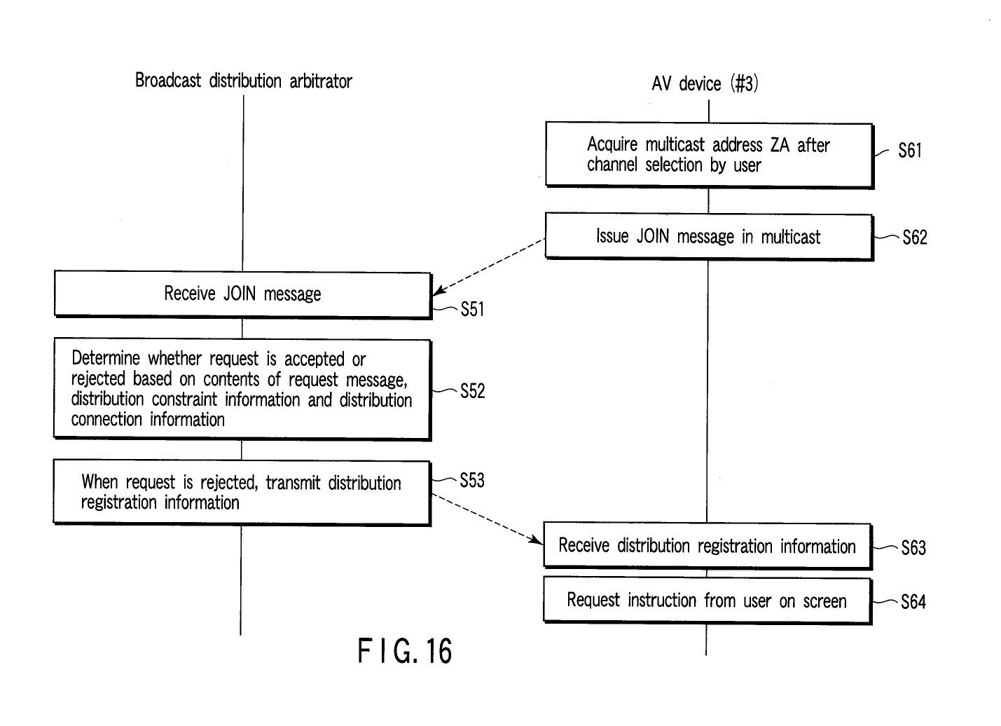

An example of a sequence of this procedure is shown in FIG. 16. The AV device (#3) acquires the multicast address ZA using meta information associated with an electron program list (step S61) and issues a JOIN message of ICMP (step S62), when a user performs a channel selection on the GUI screen of the electronic program list or a direct channel selection using a wireless remote controller as well the first embodiment.

The broadcast distribution arbitrator 10 receives the JOIN message of ICMP (i.e., content distribution request message) (step S51), and determines whether the distribution request message from the AV device (#3) can be accepted, referring to the content of the message, the distribution constraint information and the distribution connection information (step S52).

When the broadcast distribution arbitrator 10 determines to accept the message, the process similar to the first embodiment is executed. However, when the arbitrator 10 determines to refuse the message, the distribution registration information transmitter 16 generates distribution registration information from the distribution request channel receiving mode information, identification information such as the IP address of the AV device of source of distribution request and the distribution connection information currently used, and sends it to the AV device (#3) of source of distribution request (step S53).

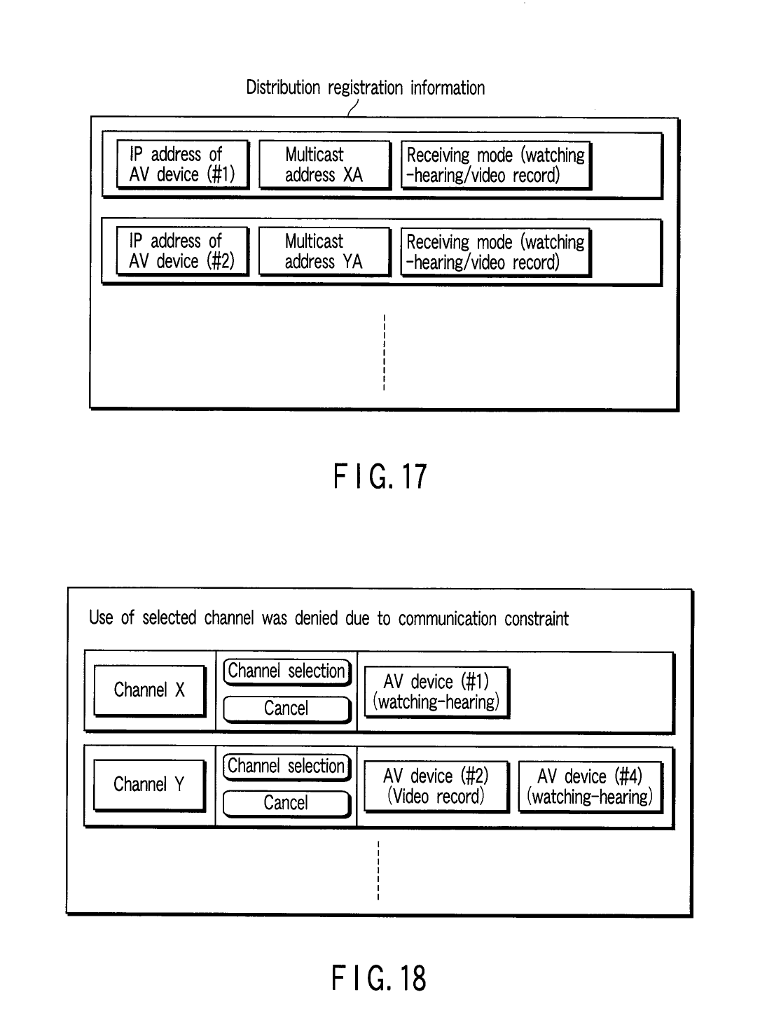

An example of a format of the distribution registration information is shown in FIG. 17. In this example, the distribution registration information is assumed to be information obtained by removing a next query time from all entries of the distribution request channel receiving mode information. The format of the distribution registration information is not limited to the above and various kinds of formats are available.

When the AV device (#3) receives the distribution registration information (step S63), it informs the user of that use of the channel selected by the user on the screen is refused due to the communication constraint, based on the distribution registration information, and displays a list of channels distributed to other AV devices 20.

GUI displaying is performed for requesting a process for selecting the channel identical to one of the AV devices (#1, #2) from the list or a process for canceling one of the distributed channels and giving priority for channel selection to the AV device (#3) (step S64).

An example of the GUI screen is shown in FIG. 18. In this example, a message sentence is displayed on the top of the screen, and information capable of specifying the channel, a channel selection button for selecting the channel, a cancel button for canceling the channel, information capable of specifying the AV device receiving the channel and an watching/hearing condition of each AV device are displayed for every channel.

In other words, when the channel selection button is pushed, the AV device (#3) cancels the former request and selects the channel corresponding to the channel selection button. When the cancel button is pushed, the AV device 20 receiving the channel corresponding to the cancel button stops the receiving and gives priority to the request issued by the AV device (#3).

The GUI screen (and distribution registration information for forming the GUI screen) is not limited to the above, and various kinds of variations are available. The GUI screen may provide various information such as a communication band used for the channel, attribute information (e.g., a tile of a content, a genre, a performer name, an on-air program, a on-air CM, an elapsed time from a program start, a time to a program end), attribute information (performance, a room in which the AV device is installed, a user name or a name substituting for the user name) of the AV device using the channel.

The case that a user selects a channel on the basis of presented information is explained hereinbefore. However, a rule to determine priority of channels is prepared based on various information and the priority control may be automatically performed according to priority obtained by applying the rule to the above various kinds of information. In this case, the receiving priority is given to a channel having a high priority in a range to satisfy the constraint.

The order of priority obtained by applying the rule to the information may be presented to a user and provided as information for a user to determine a channel selection.

This rule has various variations as follows:

(1) giving priority to a channel including a video recording in the watching/hearing condition than the channel having no video recoding in the watching/hearing condition,

(2) giving a priority to each AV device 20 beforehand, and giving a higher priority to the channel which the AV device 20 employs of this priority takes first priority,

(3) giving a priority to a genre of a content beforehand, a channel broadcasting the content of high priority being more prioritized, and

(4) selecting a channel so that the number of channels increases.

In the configuration that a user selects, when the user selects a channel existing in the GUI list (when a channel selection button is pushed), a desired channel selection is realized by executing the same process as the sequence shown in FIGS. 9 and 12.

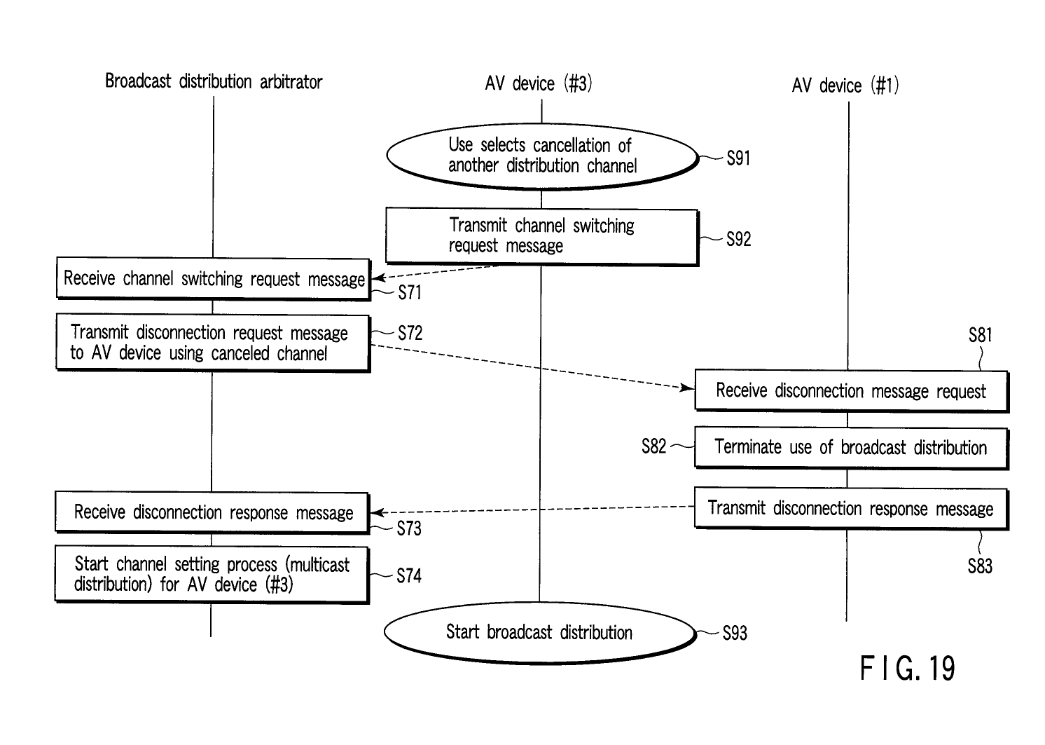

On the other hand, when a user selects cancellation of any one of channels distributed to other AV devices from the GUI list, that is, when the user pushes a cancel button, the sequence illustrated by FIG. 19 is carried out.

A case to cancel the distributed channel X of the AV device (#1) is explained hereinafter. The AV device (#3) creates a channel switching request message including a multicast address (XA) corresponding to a to-be-cancelled channel (X) selected by a user and transmits it to the broadcast distribution arbitrator 10. The broadcast distribution arbitrator 10 receives this message (step S71), extracts the AV device (only the AV device (#1)) using the channel called for cancellation from the distribution connection information holder 13, creates a disconnection request message for all the AV devices, and transmit the message (step S72).

When the AV device (#1) receives the disconnection request message (step S81), it starts an end process of the broadcast distribution utilization (step S82). When the AV device (#1) stops a broadcast distribution receiving process, it transmits a LEAVE message (receiving end notification message) of IGMP in the same subnet in multicast (step S83). When the broadcast distribution arbitrator 10 receives the LEAVE message of ICMP from the AV device (#1) (step S73), it deletes an entry of the AV device (#1) held in the distribution connection information holder 13 and distribution request channel receiving mode acquirer 15. As a result, the AV device (#1) withdraws from the multicast group belonging to the multicast address XA corresponding to the channel X.

In the above description, an object entry is assumed to be only the AV device (#1). However, when a plurality of AV devices exist, each AV device is subjected to the disconnection process or the deleting process of the corresponding entry in the broadcast distribution arbitrator 10 to be withdrawn from the multicast group. When the broadcast distribution arbitrator 10 completes the above process, it carries out the processes similar to the sequences shown in FIGS. 9 and 12 based on the distribution request from the AV device (#3) (step S74), whereby a desired channel selection is realized by the AV device (#3) (step S93).

In the first and second embodiments, only one provider side system 4 and only one broadcast distribution server 40 are assumed to exist. However, a plurality of provider side systems and broadcast distribution servers may exist. On that occasion, if the constraints are set individually for the systems and servers, the broadcast distribution arbitrator 10 has only to control them so as to satisfy all the constraints set individually.

Each function described above are implemented by being written as software and processed by the computer having a suitable mechanism. Also, the embodiments can be implemented as programs for making a computer execute a predetermined procedure, for making a computer function as given means or for making a computer realize a given function. In addition, the embodiments can be carried out as a computer readable recording medium recorded the program.

According to the present invention, the distribution channels distributed in home and limited in number can be adaptively utilized between a plurality of AV devices.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A content distribution arbitration apparatus built in a LAN connected to a plurality of content receivers receiving a content transmitted in multicast from a content distribution server through a network, the apparatus comprising:
a first memory to store constraint information indicating the number of channels capable of receiving contents simultaneously in the LAN and a communication band;
a second memory to store connection information indicating a distribution channel used by each of the content receivers which receives a content;
a message receiver to receive a message for requesting distribution of content by a desired distribution channel; and
a controller to determine whether the message is accepted based on request of the message, the constraint information and the connection information.

2. The apparatus according to claim 1, wherein the controller examines whether the distribution channel identical to the distribution channel concerning the message is contained in the connection information, and determines acceptance of the connection information when it is included in the connection information.

3. The apparatus according to claim 1, mounted on a router of the LAN.

4. The apparatus according to claim 1, mounted on a content receiver connected to the position capable of certainly receiving the message transmitted by the content receiver aside from the content receiver currently receiving before the router of the LAN.

5. The apparatus according to claim 1, mounted on the content receiver connected to a position being a node independent from the router of the LAN and the content receiver and capable of certainly receiving the message transmitted by the content receiver before the router of the LAN.

6. The apparatus according to claim 1, wherein the controller examines whether the distribution channel identical to the distribution channel concerning the message is contained in the connection information, and wherein the controller examines whether the constraint indicated by the constraint information is satisfied if the message is to be accepted when the distribution channel is not included in the connection information, and determines acceptance of the message when the constraint is satisfied.

7. The apparatus according to claim 6, wherein the constraint represented by the constraint information is a constraint that the upper limit of the number of channels capable of receiving contents simultaneously is n, and the constraint represented by the constraint information is satisfied when the number m of kinds of distribution channels contained in the connection information is less than n.

8. The apparatus according to claim 6, mounted on a router of the LAN.

9. The apparatus according to claim 6, mounted on a content receiver connected to the position capable of certainly receiving the message transmitted by the content receiver aside from the content receiver currently receiving before the router of the LAN.

10. The apparatus according to claim 6, mounted on the content receiver connected to a position being a node independent from the router of the LAN and the content receiver and capable of certainly receiving the message transmitted by the content receiver before the router of the LAN.

11. The apparatus according to claim 6, wherein when the constraint is not satisfied, the controller determines refuse of the message.

12. The apparatus according to claim 6, wherein when the constraint is not satisfied, the controller determines to refuse the message or to forcibly stop any one of the content receivers receiving currently the content via the distribution channels and to accept the message.

13. The apparatus according to claim 12, wherein the controller determines according to selection of a user or a rule prepared beforehand.

14. The apparatus according to claim 1, further comprising:
an acquirement unit configured to acquire receiving mode information indicating a receiving mode for content that the content receiver transmitted the message receives using a distribution channel concerning the message; and
a provider unit configured to provide distribution registration information generated from at least the connection information concerning the channel, information on the content receiver using a channel currently used and the receiving mode information concerning the channel to the content receiver transmitted a message newly;

15. The apparatus according to claim 14, wherein the distribution registration information includes information concerning the content transmitted via the channel.

16. The apparatus according to claim 14, wherein when the controller is unable to accept a message transmitted from the content receiver newly, the provider unit provides the distribution registration information to the content receiver transmitted the message newly.

17. The apparatus according to claim 16, further comprising an issue unit configured to issue a disconnection request to the content receiver using the channel currently receiving content when a request for switching the channel during receiving to another channel is received from the content receiver transmitted the message newly after the provider provided the distribution registration information.

18. The apparatus according to claim 14, wherein the receiving mode information is information representing whether it is a receiving mode with a video recording.

19. A content distribution arbitration method using a content distribution arbitration apparatus built in a LAN connected to a plurality of content receivers receiving a content transmitted in multicast from a content distribution server through a network, the method comprising:
storing, in a first memory, constraint information indicating the number of channels capable of receiving contents simultaneously in the LAN and a communication band,
storing, a second memory, connection information indicating a distribution channel used by each of the content receivers which receives a content;
receiving a message for requesting distribution of content by a desired distribution channel; and
determining whether the message is accepted based on request of the message, the constraint information and the connection information.

20. A computer readable storage medium storing instructions of a computer program which when executed by a computer results in performance of steps comprising:
storing, in a first memory, constraint information indicating the number of channels capable of receiving contents simultaneously in the LAN and a communication band,
storing, a second memory, connection information indicating a distribution channel used by each of the content receivers which receives a content;
receiving a message for requesting distribution of content by a desired distribution channel; and
determining whether the message is accepted based on request of the message, the constraint information and the connection information.
